(19) United States
(12) Patent Application Publication
(10) Pub. No.: US 2017/0190593 A1
(43) Pub. Date: Jul. 6, 2017

(54) METHOD FOR PRODUCING TUNGSTEN COMPLEX OXIDE PARTICLES

(71) Applicant: NISSHIN ENGINEERING INC., Tokyo (JP)

(72) Inventors: Yoshifumi SAKAI, Fujimino-city, Saitama (JP); Daisuke SATO, Fujimino-city, Saitama (JP); Keitaroh NAKAMURA, Fujimino-city, Saitama (JP); Akihiro KINOSHITA, Fujimino-city, Saitama (JP)

(21) Appl. No.: 15/315,633

(22) PCT Filed: Jun. 1, 2015
(86) PCT No.: PCT/JP2015/065773

§ 371 Date: Dec. 1, 2016

(30) Foreign Application Priority Data
Jun. 5, 2014 (JP) 2014-116771

(51) Int. Cl. C01G 41/00; B01J 19/08

(52) U.S. Cl. CPC C01G 41/006; B01J 19/08; B01J 2219/089; B01J 2219/0898; B01J 2219/0869; C01P 2006/60; C01P 2002/72

(57) ABSTRACT

The purpose/problem of the present invention is to provide a method for producing tungsten complex oxide particles useful as a heat shield material or the like that permits inexpensive production of a stable composition. This method for producing tungsten complex oxide particles includes a step for preparing a dispersion in which a raw material powder has been dispersed, a step for feeding the dispersion into a thermal plasma flame, and a step for supplying gas containing oxygen to the terminal portion of the thermal plasma flame and producing tungsten complex oxide particles. The dispersion preferably includes a carbon element.

### TECHNICAL FIELD

The present invention relates to a method of producing tungsten complex oxide particles having a median particle size ranging from several nm to 1000 nm, particularly to a method of producing tungsten complex oxide particles by a thermal plasma process using a carbon element-containing dispersion as a raw material.

### BACKGROUND ART

At present, tungsten complex oxides are used for piezoelectric elements, electrostrictive elements, magnetostrictive elements and heat ray shielding materials. Several methods of producing particles or the like of such tungsten complex oxides have been heretofore proposed (see Patent Literatures 1 and 2).

Patent Literature 1 describes a method of obtaining an infrared shielding film by adding one or more media selected from UV curable resins, thermoplastic resins, thermosetting resins, cold setting resins, metal alkoxides, and hydrolytic polymerization products of metal alkoxides to a solution containing dispersed infrared shielding material fine particles to prepare a coating solution, applying the coating solution (solution containing dispersed infrared shielding material fine particles) onto a base surface to form a coating film, and evaporating a solvent from the coating film. An infrared shielding optical member is composed of a base and the foregoing infrared shielding film formed on a surface of the base.

In the solution containing dispersed infrared shielding material fine particles, infrared shielding material fine particles composed of tungsten oxide fine particles represented by a general formula of WyOz (where W is tungsten, O is oxygen, and 2.2≦z/y≦2.999) or/and composite tungsten oxide fine particles represented by a general formula of MxWyOz (where M is one or more elements selected from H, He, alkali metals, alkaline earth metals, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi and I, W is tungsten, O is oxygen, 0.001≦x/y≦1, and 2.2≦z/y≦3) are contained in a solvent, and the infrared shielding material fine particles have a particle size distribution, as measured by dynamic light scattering, in which the 50% diameter is 10 nm to 30 nm, the 95% diameter is 20 nm to 50 nm, and the average particle size is 10 nm to 40 nm.

Patent Literature 1 describes that the tungsten oxide fine particles represented by the general formula WyOz and the composite tungsten oxide fine particles represented by the general formula of MxWyOz can be obtained by subjecting an ammonium tungstate aqueous solution or a tungsten hexachloride solution, used as a starting material, to thermal treatment in an inert gas atmosphere or a reducing gas atmosphere.

In a method of producing composite tungsten oxide ultrafine particles described by Patent Literature 2, use is made of, as a raw material, powder obtained by mixing an M element compound and a tungsten compound so that the ratio between M and W elements becomes the same as that in a general formula MxWyOz (where M is the M element described below, W is tungsten, O is oxygen, 0.001≦x/y≦1, and 2.0<z/y≦3.0) having a target composition, or a composite tungsten oxide represented by a general formula MxWyOz (where M is the M element, W is tungsten, O is oxygen, 0.001≦x/y≦1, and 2.0<z/y≦3.0) and produced by a conventional method.

The raw material and a carrier gas are supplied into thermal plasma generated in an atmosphere containing an inert gas alone or a mixed gas of an inert gas and a hydrogen gas to cause the raw material to be subjected to an evaporation process and a condensation process. As a result, composite tungsten oxide ultrafine particles having a single-phase crystal phase, having the target composition and having a particle size of up to 100 nm are generated. The M element refers to one or more elements selected from H, Li, Na, K, Rb, Cs, Cu, Ag, Pb, Ca, Sr, Ba, In, Tl, Sn, Si and Yb.

### CITATION LIST

### Patent Literature

Patent Literature 1: JP 2009-215487 A

Patent Literature 2: JP 2010-265144 A

### SUMMARY OF INVENTION

### Technical Problems

As described by Patent Literature 1, the tungsten oxide fine particles and the composite tungsten oxide fine particles represented by the general formula MxWyOz are obtained by carrying out thermal treatment in an inert gas atmosphere or a reducing gas atmosphere. In general, composite tungsten oxide fine particles are obtained through thermal treatment in a reducing gas atmosphere. In the case of employing thermal treatment in a reducing gas atmosphere, the cost for a device is increased, which leads to a higher production cost, disadvantageously.

Aside from that, in the method of producing composite tungsten oxide ultrafine particles by supplying the raw material and the carrier gas into the thermal plasma generated in an atmosphere containing an inert gas alone or a mixed gas of an inert gas and a hydrogen gas as described in Patent Literature 2, powder is used as the raw material to be supplied to the thermal plasma, and the powder is directly supplied to the thermal plasma. Due to the pulsation during supply of the raw material powder and the segregation of the raw material powder, the raw material composition is not stabilized, disadvantageously. The technique of Patent Literature 2 does not make it possible to produce composite tungsten oxide ultrafine particles with a stable composition.

An object of the present invention is to solve the problems inherent in the prior art and to provide a production method that makes it possible to produce tungsten complex oxide particles with a stable composition at low cost.

### Solution to Problems

In order to attain the foregoing object, the present invention provides a method of producing tungsten complex oxide particles, comprising: a step of preparing a dispersion liquid in which raw material powder is dispersed; a step of supplying the dispersion liquid into a thermal plasma flame; and a step of forming tungsten complex oxide particles by supplying an oxygen-containing gas to a terminating portion of the thermal plasma flame.

Preferably, the dispersion liquid contains carbon element. A solvent used for the dispersion liquid preferably, but not necessarily, contains carbon element. In this case, the solvent is for instance an organic solvent, and examples of a carbon element-containing solvent include alcohols such as ethanol. The raw material powder preferably contains carbon element. The carbon element is for example contained in the form of at least one of a carbide, a carbonate and an organic compound. For instance, the thermal plasma flame is derived from oxygen gas, and the oxygen-containing gas is a mixed gas of air gas and nitrogen gas.

### Advantageous Effects of Invention

The present invention makes it possible to produce tungsten complex oxide particles with a stable composition at low cost.

### BRIEF DESCRIPTION OF DRAWINGS

FIG. 1 is a graph for explaining the evaluation of optical characteristics of tungsten complex oxide particles.

FIG. 2 is a schematic view showing a fine particle production apparatus that is used in a method of producing tungsten complex oxide particles according to an embodiment of the invention.

FIG. 3 is a flowchart showing the method of producing tungsten complex oxide particles according to the embodiment of the invention.

FIG. 4 is a graph showing analysis results for CsₓWO₃ particles obtained by the production method according to the embodiment of the invention, analyzed by X-ray diffractometry.

FIG. 5 is a graph showing evaluation results for optical characteristics of CsₓWO₃ particles obtained by the production method according to the embodiment of the invention.

### DESCRIPTION OF EMBODIMENTS

On the following pages, the method of producing tungsten complex oxide particles according to the invention is described in detail with reference to a preferred embodiment shown in the accompanying drawings.

Tungsten complex oxide particles of the invention have the composition represented by, for instance, a general formula MxWyOz, where M is at least one element selected from H, He, alkali metals, alkaline earth metals, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, V, Mo, Ta, Re, Be, Hf, Os, Bi and I, W is tungsten, and O is oxygen.

The tungsten complex oxide particles can be used for piezoelectric elements, electrostrictive elements, magnetostrictive elements and heat ray shielding materials.

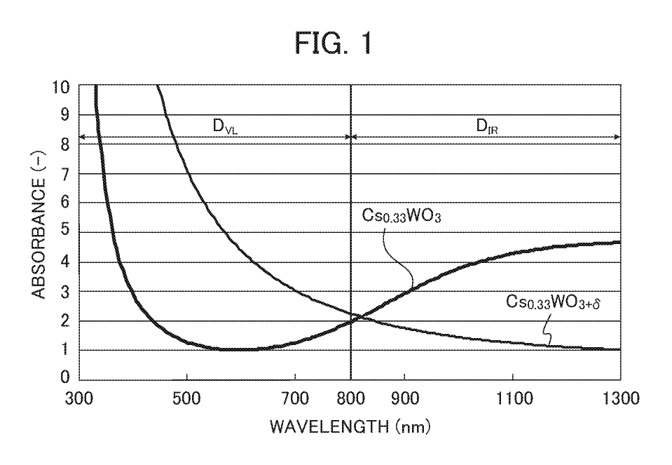

FIG. 1 is a graph for explaining the evaluation of optical characteristics of tungsten complex oxide particles. For example, tungsten complex oxide particles represented by Cs_{0.33}WO₃ have the optical characteristics shown in FIG. 1, where the absorbance in an infrared light region D_{IR} is higher than that in a visible light region D_{VL}. The tungsten complex oxide particles represented by Cs_{0.33}WO₃ have a heat ray shielding effect owing to the optical characteristics above and therefore can be used for a heat ray shielding material.

The tungsten complex oxide particles represented by Cs_{0.33}WO₃ are obtained by subjecting oxide particles represented by Cs_{0.33}WO_{3+δ} to reduction treatment. The degree of oxidation of the oxide particles represented by Cs_{0.33}WO_{3+δ} is higher by the amount corresponding to δ than that of the tungsten complex oxide particles represented by Cs_{0.33}WO₃.

The oxide particles represented by Cs_{0.33}WO_{3+δ} have a higher absorbance in the visible light region D_{VL} and a lower absorbance in the infrared light region D_{IR} than those of the tungsten complex oxide particles represented by Cs_{0.33}WO₃ and therefore are not suitable for a heat ray shielding purpose.

In measurement of the absorbance of the tungsten complex oxide particles represented by Cs_{0.33}WO₃ shown in FIG. 1, the tungsten complex oxide particles were dispersed in ethanol to measure the absorbance thereof with an infrared visible spectrophotometer. As to the absorbance of the oxide particles represented by Cs_{0.33}WO_{3+δ}, these oxide particles were dispersed in ethanol to measure the absorbance thereof with an infrared visible spectrophotometer.

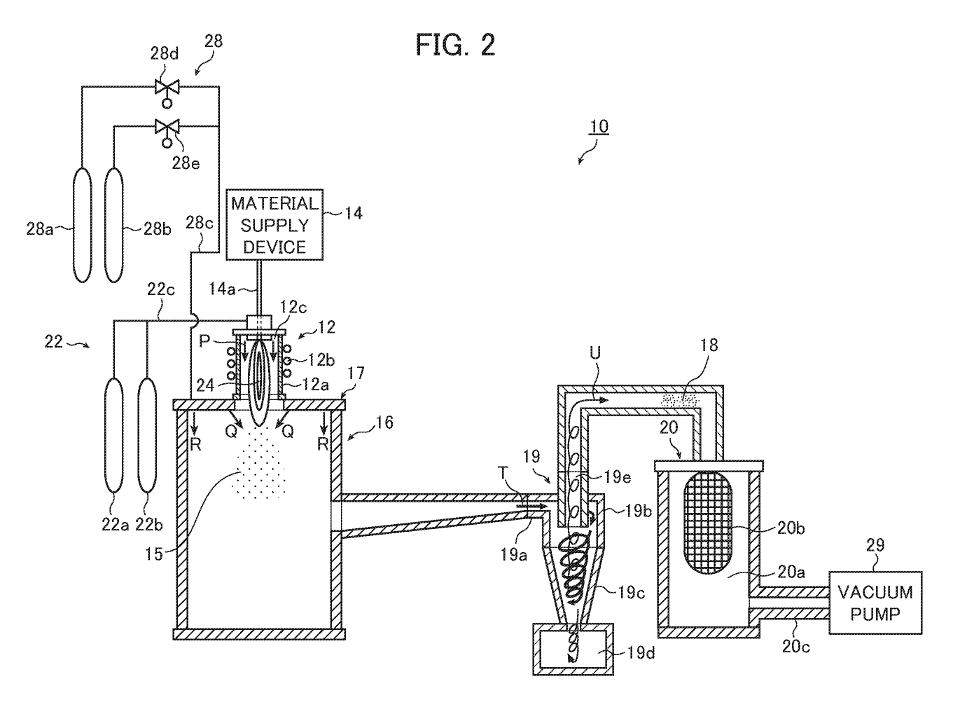

FIG. 2 is a schematic view showing a fine particle production apparatus that is used in the method of producing tungsten complex oxide particles according to the embodiment of the invention.

A fine particle production apparatus 10 (hereinafter referred to simply as “production apparatus 10”) shown in FIG. 2 is used to produce tungsten complex oxide particles.

The production apparatus 10 includes a plasma torch 12 generating thermal plasma, a material supply device 14 supplying raw material powder for producing tungsten complex oxide particles into the plasma torch 12 in the form of a dispersion liquid, a chamber 16 serving as a cooling tank for producing primary fine particles 15 of the tungsten complex oxide particles, a cyclone 19 removing, from the produced primary fine particles 15, coarse particles having a particle size equal to or larger than an arbitrarily specified particle size, and a collecting section 20 collecting secondary fine particles 18 of the tungsten complex oxide particles having a desired particle size as obtained by classification in the cyclone 19.

Various devices in, for example, JP 2007-138287 A may be used for the material supply device 14, the chamber 16, the cyclone 19 and the collecting section 20.

In this embodiment, a dispersion liquid prepared by dispersing raw material powder corresponding to the composition of tungsten complex oxide particles in a solvent is used in the production of the tungsten complex oxide particles. The dispersion liquid preferably contains carbon element. The dispersion liquid may also be called “slurry” in the following description.

The slurry contains carbon element. In obtaining a slurry containing carbon element, there are three patterns including a pattern in which raw material powder contains carbon element, a pattern in which a solvent used for the dispersion liquid contains carbon element, and a pattern in which a carbon element-containing substance is added to a solvent.

One example of the raw material powder containing carbon element is mixed powder of CsCO₃ powder and WO₃ powder. In addition, carbonates such as Cs₂CO₃ powder and carbide powders such as WC powder and W₂C powder may be used. When raw material powder does not contain carbon element, a carbon element-containing substance may be added. Exemplary carbon element-containing substances include carbon-based polymer compounds such as polyethylene glycol and organic substances such as sugar and flour. Thus, carbon element is contained in the form of at least one of a carbide, a carbonate and an organic compound.

The average particle size of raw material powder is appropriately set to allow the raw material powder to be readily evaporated in a thermal plasma flame, and is, for example, up to 100 μm, preferably up to 10 μm and even more preferably up to 3 μm. The average particle size may be measured using the BET method.

The carbon element-containing solvent is, for instance, an organic solvent. Specific examples thereof include alcohols, ketones, kerosenes, octanes and gasolines. Usable alcohols include, for instance, ethanol, methanol, propanol and isopropyl alcohol as well as industrial alcohols. Carbon element in the slurry serves to supply carbon that reacts with a part of the raw material powder to reduce the part. Therefore, it is preferable to use an alcohol that is easily decomposed by a thermal plasma flame 24, and thus lower alcohols are preferred. The solvent preferably contains no inorganic substance. If the raw material powder contains carbon element, the solvent does not necessarily need to contain carbon element and may be, for instance, water. When water is used as the solvent, powder containing carbon as its main ingredient is added to the raw material powder.

In the slurry, the raw material powder and the solvent are present at a mixing ratio (raw material powder:solvent) of, for example, 4:6 (40%:60%) in terms of weight ratio.

The plasma torch 12 includes a quartz tube 12a and a coil 12b for high frequency oscillation surrounding the outside of the quartz tube. On top of the plasma torch 12, a supply tube 14a to be described later which is for supplying raw material powder into the plasma torch 12 in the form of slurry containing the raw material powder as will be described later is provided at the central portion thereof. A plasma gas supply port 12c is formed in the peripheral portion of the supply tube 14a (on the same circumference). The plasma gas supply port 12c is in a ring shape.

A plasma gas supply source 22 has a first gas supply section 22a and a second gas supply section 22b, which are connected to the plasma gas supply port 12c through pipe 22c. Although not shown, the first and second gas supply sections 22a and 22b are each provided with a supply amount adjuster such as a valve for adjusting the supply amount. Plasma gas is supplied from the plasma gas supply source 22 into the plasma torch 12 through the plasma gas supply port 12c.

For example, two types of plasma gases such as oxygen gas and argon gas are prepared. Oxygen gas is stored in the first gas supply section 22a, while argon gas is stored in the second gas supply section 22b. Oxygen gas and argon gas are supplied as plasma gases from the first and second gas supply sections 22a and 22b of the plasma gas supply source into the plasma torch 12 in a direction indicated by arrow P after having passed through the ring-shaped plasma gas supply port 12c via the pipe 22c. Then, a high frequency voltage is applied to the coil 12b for high frequency oscillation to generate the thermal plasma flame 24 in the plasma torch 12.

The plasma gases are not limited to oxygen gas and argon gas. As long as oxygen gas is included, for example, helium gas or the like may be used as an inert gas instead of argon gas. Alternatively, a plurality of inert gases such as argon gas and helium gas may be mixed with oxygen gas.

It is necessary for the thermal plasma flame 24 to have a higher temperature than the boiling point of the raw material powder. On the other hand, the thermal plasma flame 24 preferably has a higher temperature because the raw material powder is more easily converted into a gas phase state. However, there is no particular limitation on the temperature. For instance, the thermal plasma flame 24 may have a temperature of 6,000° C., and in theory, the temperature is deemed to reach around 10,000° C.

The ambient pressure inside the plasma torch 12 is preferably up to atmospheric pressure. The ambient pressure of up to atmospheric pressure is not particularly limited and is, for example, in a range of 0.5 to 100 kPa.

The outside of the quartz tube 12a is surrounded by a concentrically formed tube (not shown), and cooling water is circulated between this tube and the quartz tube 12a to cool the quartz tube 12a with the water, thereby preventing the quartz tube 12a from having an excessively high temperature due to the thermal plasma flame 24 generated in the plasma torch 12.

The material supply device 14 is connected to the upper portion of the plasma torch 12 through the supply tube 14a. The material supply device 14 is configured to supply a dispersion liquid containing the raw material powder into the thermal plasma flame 24 in the plasma torch 12.

For example, the device disclosed in JP 2011-213524 A may be used as the material supply device 14. In this case, the material supply device 14 includes a vessel (not shown) for introducing a slurry (not shown), an agitator (not shown) agitating the slurry in the vessel, a pump (not shown) for supplying the slurry into the plasma torch 12 through the supply tube 14a with a high pressure applied thereto, and an atomization gas supply source (not shown) which supplies atomization gas for supplying the slurry into the plasma torch 12 in the form of droplets. The atomization gas supply source corresponds to the carrier gas supply source. The atomization gas is also called carrier gas.

The material supply device 14 supplying the raw material powder in the form of slurry supplies atomization gas, to which a push-out pressure is applied, from the atomization gas supply source together with the slurry into the thermal plasma flame 24 in the plasma torch 12 through the supply tube 14a. The supply tube 14a has a two-fluid nozzle mechanism for spraying the slurry into the thermal plasma flame 24 in the plasma torch and converting it into droplets, whereby the slurry can be sprayed into the thermal plasma flame 24 in the plasma torch 12, in other words, the slurry can be converted into droplets. As with the carrier gas, for example, inert gases such as argon gas and helium gas mentioned as the plasma gases above may be used for the atomization gas.

As described above, the two-fluid nozzle mechanism is capable of applying a high pressure to the slurry and atomizing the slurry with gas, i.e., atomization gas (carrier gas), and is used as a method for converting the slurry into droplets.

It should be noted that the nozzle mechanism is not limited to the above-described two-fluid nozzle mechanism but a single-fluid nozzle mechanism may also be used. Other exemplary methods include a method which involves causing a slurry to fall at a constant speed onto a rotating disk so as to convert the slurry into droplets (to form droplets) by the centrifugal force, and a method which involves applying a high voltage to the surface of a slurry to convert the slurry into droplets (to form droplets).

The chamber 16 is provided below and adjacent to the plasma torch 12. The chamber 16 is a section in which the primary fine particles 15 of the tungsten complex oxide particles are formed from the dispersion liquid containing the raw material powder as supplied into the thermal plasma flame 24 in the plasma torch 12 and also serves as a cooling tank.

A gas supply device 28 includes a first gas supply source 28a, a second gas supply source 28b and pipe 28c, and further includes a compressor which applies push-out pressure to mixed gas supplied into the chamber 16 which will be described later, and a pressure application device such as a blower (not shown). The gas supply device 28 is also provided with a pressure control valve 28d which controls the amount of gas supplied from the first gas supply section 28a and a pressure control valve 28e which controls the amount of gas supplied from the second gas supply section 28b. For example, the first gas supply source 28a stores air gas, while the second gas supply source 28b stores oxygen gas.

The gas supply device 28 supplies oxygen-containing gas, for example, mixed gas of air gas and oxygen gas at a predetermined angle in a direction of arrow Q toward a tail portion of the thermal plasma flame 24, that is, an end of the thermal plasma flame 24 on the opposite side from the plasma gas supply port 12c, i.e., the terminating portion of the thermal plasma flame 24, and also supplies the mixed gas from above to below along a side wall of the chamber 16, that is, in a direction of arrow R shown in FIG. 2.

In addition to the function as a cooling gas to quench a tungsten complex oxide product produced in the chamber 16 to form the primary fine particles 15 of the tungsten complex oxide particles as will be described later in detail, the mixed gas supplied from the gas supply device 28 has additional effects including contribution to the classification of the primary fine particles 15 in the cyclone 19. Gas supplied to the terminating portion of the thermal plasma flame 24 is not particularly limited as long as it is gas containing oxygen.

The slurry introduced from the material supply device 14 is converted into droplets and supplied to the thermal plasma flame 24 in the plasma torch 12 using atomization gas at a predetermined flow rate. As a result, the slurry is converted into a gaseous substance, that is, a gas phase state. Alcohol in the slurry is decomposed to generate carbon. The gaseous substance and carbon react with each other to reduce a part of the raw material powder. Subsequently, due to the mixed gas supplied to the thermal plasma flame 24 in the direction of the arrow Q, the reduced raw material powder is oxidized by oxygen gas present in the mixed gas whereby the tungsten complex oxide product is produced. Then, the tungsten complex oxide product is quenched by the mixed gas in the chamber 16 to thereby produce the primary fine particles 15 of the tungsten complex oxide particles. In this process, the mixed gas supplied in the direction of the arrow R prevents the primary fine particles 15 from adhering to the inner wall of the chamber 16.

As shown in FIG. 2, the cyclone 19 for classifying the produced primary fine particles 15 based on a desired particle size is provided on a lower lateral side of the chamber 16. The cyclone 19 includes an inlet tube 19a which supplies the primary fine particles 15 from the chamber 16, a cylindrical outer casing 19b connected to the inlet tube 19a and positioned in an upper portion of the cyclone 19, a truncated conical part 19c continuing downward from a lower portion of the outer casing 19b and having a gradually decreasing diameter, a coarse particle collecting chamber 19d connected to a lower side of the truncated conical part 19c for collecting coarse particles having a particle size equal to or larger than the above-mentioned desired particle size, and an inner tube 19e connected to the collecting section 20 to be described later in detail and projecting from the outer casing 19b.

A gas stream containing the primary fine particles 15 produced in the chamber 16 is blown into the cyclone 19 from the inlet tube 19a thereof along the inner peripheral wall of the outer casing 19b, and this gas stream flows in the direction from the inner peripheral wall of the outer casing 19b to the truncated conical part 19c as indicated by arrow T in FIG. 2, thereby forming a downward swirling stream.

When the above-described downward swirling stream is inverted to form an upward stream, coarse particles cannot follow the upward stream due to the balance between the centrifugal force and drag but come down along the side surface of the truncated conical part 19c and are collected in the coarse particle collecting chamber 19d. Fine particles which were influenced by the drag more than the centrifugal force are discharged to the outside of the system from the inner tube 19e along with the upward stream on the inner wall of the truncated conical part 19c.

The apparatus is configured such that a negative pressure (suction force) is generated by the collecting section 20 as will be described in detail below and applied through the inner tube 19e. The apparatus is also configured such that, under the negative pressure (suction force), the tungsten complex oxide particles separated from the above-mentioned swirling gas stream are sucked as indicated by arrow U and sent to the collecting section 20 through the inner tube 19e.

On the extension of the inner tube 19e, which is an outlet for the gas stream in the cyclone 19, the collecting section 20 for collecting the secondary fine particles (tungsten complex oxide particles) 18 having a desired particle size on the order of nanometers is provided. The collecting section 20 includes a collecting chamber 20a, a filter 20b provided in the collecting chamber 20a, and a vacuum pump 29 connected through a pipe 20c provided below inside the collecting chamber 20a. The fine particles delivered from the cyclone 19 are sucked by the vacuum pump 29 to be introduced into the collecting chamber 20a, and remain on the surface of the filter 20b and are then collected.

It should be noted that the number of cyclones used in the method of producing tungsten complex oxide particles according to the invention is not limited to one but may be two or more.

Fine particles just after the production collide with each other to form agglomerates, thereby causing unevenness in particle size, which may reduce the quality. However, dilution of the primary fine particles 15 with the mixed gas supplied in the direction of the arrow Q toward the tail portion (terminating portion) of the thermal plasma flame prevents the fine particles from colliding with each other to agglomerate together.

On the other hand, the mixed gas supplied in the direction of the arrow R along the inner wall of the chamber 16 prevents the primary fine particles 15 from adhering to the inner wall of the chamber 16 in the process of collecting the primary fine particles 15, whereby the yield of the produced primary fine particles 15 is improved.

Under these circumstances, the mixed gas needs to be supplied in an amount sufficient to quench the resulting tungsten complex oxide particles in the process of producing the primary fine particles 15 of the tungsten complex oxide particles and is preferably supplied in such an amount that the flow rate enabling classification of the primary fine particles 15 at any classification point in the downstream cyclone 19 is obtained and that stabilization of the thermal plasma flame 24 is not hindered. The supply method, supply position and the like of the mixed gas are not particularly limited as long as the stabilization of the thermal plasma flame 24 is not hindered. In the fine particle production apparatus 10 of the embodiment, a circumferential slit is formed in a top plate 17 to supply the mixed gas but any other method or position may be applied as long as the method or position applied enables reliable supply of gas on the path from the thermal plasma flame 24 to the cyclone 19.

The method of producing tungsten complex oxide particles using the above-described production apparatus 10 and tungsten complex oxide particles produced by this production method are described below.

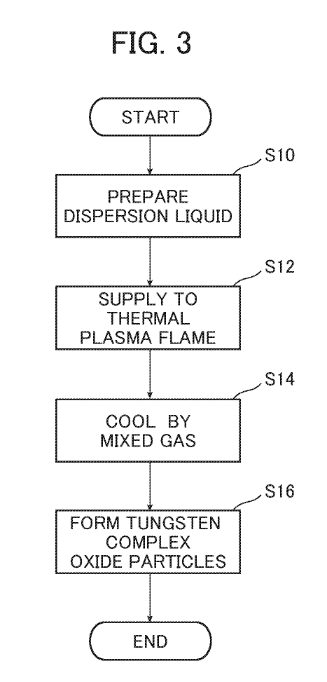

FIG. 3 is a flowchart showing the method of producing tungsten complex oxide particles according to the embodiment of the invention.

In this embodiment, a dispersion liquid in which raw material powder is dispersed in a solvent is prepared (Step S10), and the dispersion liquid is used to produce tungsten complex oxide particles. As the raw material powder, for instance, mixed powder of CsCO₃ powder and WO₃ powder is used. Alcohol is used for the solvent. In this example, carbon element is contained in the raw material powder and the solvent. Although not limited, the mixing ratio between the raw material powder and the alcohol in the dispersion liquid is 4:6 (40%:60%) in terms of weight ratio.

For example, argon gas and oxygen gas are used as plasma gases, and a high frequency voltage is applied to the coil 12b for high frequency oscillation to generate the thermal plasma flame 24 in the plasma torch 12. The amount of oxygen gas to be mixed is, for instance, 2.9 vol %. The thermal plasma flame 24 contains oxygen plasma derived from the oxygen gas.

A mixed gas of air gas and nitrogen gas is supplied in the direction of the arrow Q from the gas supply device to the tail portion of the thermal plasma flame 24, i.e., the terminating portion of the thermal plasma flame 24. At that time, the air gas and the nitrogen gas are supplied also in the direction of the arrow R. The amount of air gas mixed in the mixed gas is, for instance, 10 vol %.

Next, the material supply device 14 supplies the dispersion liquid in the form of droplets into the thermal plasma flame 24 in the plasma torch 12 through the supply tube 14a (Step S12). The dispersion liquid is evaporated and converted into a gas phase state by the thermal plasma flame 24, and the raw material powder and the solvent become gaseous substances. CsWO_{3+δ} is produced from the mixed powder of CsCO₃ powder and WO₃ powder. The alcohol and the raw material powder containing carbon as its main ingredient (CsCO₃ powder) in the dispersion liquid are decomposed into C, H₂O, CO, CO₂ and the like by oxygen plasma of the thermal plasma flame 24, whereby carbon is generated.

The raw material powder which is a gaseous substance reacts with C and CO, leading to the reduction. In this example, CsWO_{3+δ} and the like react with carbon to produce CsW, CsWO_{3-δ} and the like.

Subsequently, due to the mixed gas supplied to the thermal plasma flame 24 in the direction of the arrow Q, the reduced raw material powder is oxidized by oxygen present in the mixed gas and cooled by the mixed gas (Step S14). More specifically, CsW and O₂ react with each other to produce CsWO₃ as a tungsten complex oxide product, which is in turn quenched by the mixed gas, thereby obtaining CsWO₃ particles as the tungsten complex oxide particles. Primary fine particles 15 of the tungsten complex oxide particles are thus formed (Step S16).

The primary fine particles 15 produced in the chamber 16 are blown through the inlet tube 19a of the cyclone 19 together with a gas stream along the inner peripheral wall of the outer casing 19b, and this gas stream flows along the inner peripheral wall of the outer casing 19b as indicated by the arrow T in FIG. 2, thereby forming a swirling stream, which goes downward. When the above-described downward swirling stream is inverted to form an upward stream, coarse particles cannot follow the upward stream due to the balance between the centrifugal force and drag but come down along the side surface of the truncated conical part 19c and are collected in the coarse particle collecting chamber 19d. Fine particles which were influenced by the drag more than the centrifugal force are discharged to the outside of the system from the inner tube 19e along with the upward stream on the inner wall of the truncated conical part 19c.

Under the negative pressure (suction force) from the collecting section 20, discharged secondary fine particles 18 of the tungsten complex oxide particles are sucked in the direction indicated by the arrow U in FIG. 2 and delivered to the collecting section 20 through the inner tube 19e to be collected on the filter 20b of the collecting section 20. The internal pressure of the cyclone 19 at that time is preferably up to atmospheric pressure. For the particle size of the secondary fine particles 18 of the tungsten complex oxide particles, an arbitrary particle size on the order of nanometers is selected according to the intended purpose.

Thus, in this embodiment, the tungsten complex oxide particles having a uniform particle size and having a narrow particle size distribution with a median particle size ranging from several nm to 1000 nm can be thus obtained easily and reliably by merely subjecting raw material powder to plasma treatment. The average particle size of the tungsten complex oxide particles may be measured using the BET method.

Aside from that, the use of a dispersion liquid can reduce or prevent the segregation of raw material, thereby obtaining the tungsten complex oxide particles with a stable composition. In addition, what is needed is only to supply a slurry to the thermal plasma flame 24, and therefore, the tungsten complex oxide particles can be obtained at low cost.

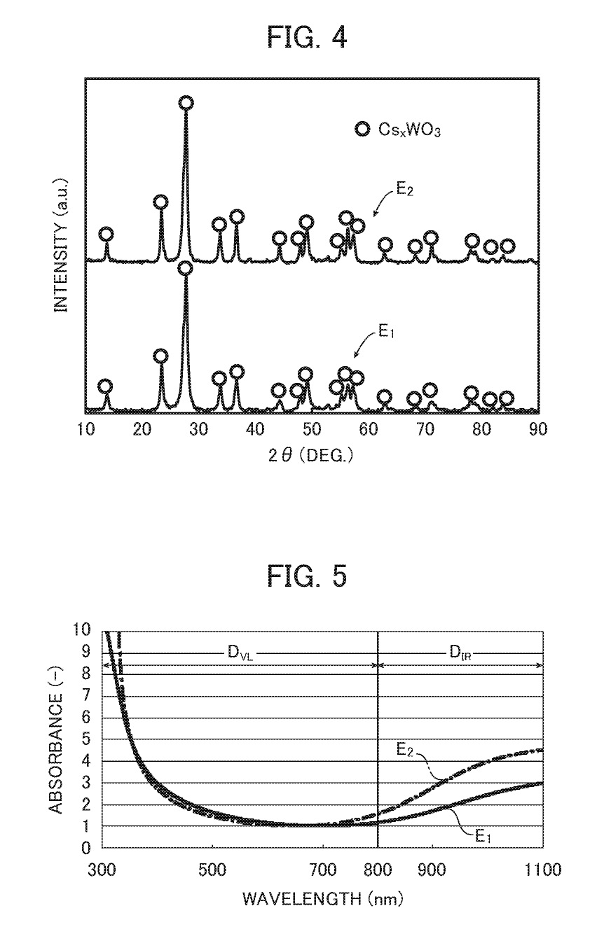

The present inventors confirmed the production of tungsten complex oxide particles by the method of producing tungsten complex oxide particles according to the invention. The results are shown in FIG. 4. In the production of tungsten complex oxide particles, cesium carbonate (Cs₂CO₃) powder and tungsten oxide (WO₃) powder were used as raw materials, and argon gas and oxygen gas were used as plasma gases.

CsₓWO₃ particles indicated by E₁ and CsₓWO₃ particles indicated by E₂ in FIG. 4 were produced under the same production conditions except that quenching gases in those cases contained air with air concentrations different from each other by 10 vol %. In the case associated with reference sign E₁, the air concentration in the quenching gas was 5 vol %, while in the case associated with reference sign E₂, the air concentration in the quenching gas was 15 vol %.

As can be seen in FIG. 4, even when CsWO₃ particles were produced with different production conditions, no peak of tungsten appeared, and CsₓWO₃ particles could be produced. In FIG. 4, the mark “∘ (circle)” represents a diffraction peak of CsₓWO₃.

The optical characteristics of CsₓWO₃ particles indicated by E₁ and CsₓWO₃ particles indicated by E₂ were evaluated. The results are shown in FIG. 5.

FIG. 5 is a graph showing evaluation results for the optical characteristics of the CsₓWO₃ particles. Note that reference signs E₁ and E₂ in FIG. 5 represent the same as those in FIG. 4.

As shown in FIG. 5, with the method of producing tungsten complex oxide particles according to the invention, the absorbance in the visible light region D_{VL} can be reduced, while the absorbance in the infrared light region D_{IR} can be increased. Therefore, the tungsten complex oxide particles of the invention can be used for heat ray shielding materials.

The present invention is basically configured as above. While the method of producing tungsten complex oxide particles according to the invention has been described above in detail, the invention is by no means limited to the foregoing embodiment and it should be understood that various improvements and modifications are possible without departing from the scope and spirit of the invention.

### REFERENCE SIGNS LIST

10 fine particle production apparatus
12 plasma torch
14 material supply device
15 primary fine particle
16 chamber
18 fine particle (secondary fine particle)
19 cyclone
20 collecting section
22 plasma gas supply source
24 thermal plasma flame
28 gas supply device

1-7. (canceled)

8. A method of producing tungsten complex oxide particles, comprising:
a step of preparing a dispersion liquid in which raw material powder is dispersed;
a step of supplying the dispersion liquid into a thermal plasma flame; and
a step of forming tungsten complex oxide particles by supplying an oxygen-containing gas to a terminating portion of the thermal plasma flame.

9. The method of producing tungsten complex oxide particles according to claim 8, wherein the dispersion liquid contains carbon element.

10. The method of producing tungsten complex oxide particles according to claim 8, wherein a solvent used for the dispersion liquid contains carbon element.

11. The method of producing tungsten complex oxide particles according to claim 9, wherein a solvent used for the dispersion liquid contains carbon element.

12. The method of producing tungsten complex oxide according to claim 10, wherein the solvent is an organic solvent.

13. The method of producing tungsten complex oxide according to claim 11, wherein the solvent is an organic solvent.

14. The method of producing tungsten complex oxide particles according to claim 8, wherein the raw material powder contains carbon element.

15. The method of producing tungsten complex oxide particles according to claim 9, wherein the raw material powder contains carbon element.

16. The method of producing tungsten complex oxide particles according to claim 14, wherein the carbon element is contained in form of at least one of a carbide, a carbonate and an organic compound.

17. The method of producing tungsten complex oxide particles according to claim 15, wherein the carbon element is contained in form of at least one of a carbide, a carbonate and an organic compound.

18. The method of producing tungsten complex oxide particles according to claim 8,
wherein the thermal plasma flame is derived from oxygen gas, and
wherein the oxygen-containing gas is a mixed gas of air gas and nitrogen gas.

19. The method of producing tungsten complex oxide particles according to claim 9,
wherein the thermal plasma flame is derived from oxygen gas, and
wherein the oxygen-containing gas is a mixed gas of air gas and nitrogen gas.

20. The method of producing tungsten complex oxide particles according to claim 10,
wherein the thermal plasma flame is derived from oxygen gas, and
wherein the oxygen-containing gas is a mixed gas of air gas and nitrogen gas.

21. The method of producing tungsten complex oxide particles according to claim 11,
wherein the thermal plasma flame is derived from oxygen gas, and
wherein the oxygen-containing gas is a mixed gas of air gas and nitrogen gas.

22. The method of producing tungsten complex oxide particles according to claim 12,
wherein the thermal plasma flame is derived from oxygen gas, and
wherein the oxygen-containing gas is a mixed gas of air gas and nitrogen gas.

23. The method of producing tungsten complex oxide particles according to claim 13,
wherein the thermal plasma flame is derived from oxygen gas, and
wherein the oxygen-containing gas is a mixed gas of air gas and nitrogen gas.

24. The method of producing tungsten complex oxide particles according to claim 14,
wherein the thermal plasma flame is derived from oxygen gas, and
wherein the oxygen-containing gas is a mixed gas of air gas and nitrogen gas.

25. The method of producing tungsten complex oxide particles according to claim 15,
wherein the thermal plasma flame is derived from oxygen gas, and
wherein the oxygen-containing gas is a mixed gas of air gas and nitrogen gas.

26. The method of producing tungsten complex oxide particles according to claim 16,
wherein the thermal plasma flame is derived from oxygen gas, and
wherein the oxygen-containing gas is a mixed gas of air gas and nitrogen gas.

27. The method of producing tungsten complex oxide particles according to claim 17,
wherein the thermal plasma flame is derived from oxygen gas, and
wherein the oxygen-containing gas is a mixed gas of air gas and nitrogen gas.
